(19) United States
(12) Patent Application Publication
(10) Pub. No.: US 2024/0194075 A1
(43) Pub. Date: Jun. 13, 2024

(54) Reversible Clearance Indicator Assembly and Method of Use

(71) Applicant: Chandler Signs, LLC, Forth Worth, TX (US)

(72) Inventors: Paul Bothner, Arlington, TX (US); Joseph Culling, Anna, TX (US)

(73) Assignee: Chandler Signs, LLC, Fort Worth, TX (US)

(21) Appl. No.: 18/076,797

(22) Filed: Dec. 7, 2022

(51) Int. Cl. G08G 1/16; G09F 7/22

(52) U.S. Cl. CPC G08G 1/165; G09F 7/22

(57) ABSTRACT

A device for providing a preliminary alert to the driver of a vehicle of an approaching overhead obstacle of a given height. A horizontal clearance bar is pivotally attached to a vertical support post which allows the clearance bar to move, after contact by a vehicle, to alert the vehicle driver to an upcoming obstruction without damaging the vehicle. The clearance bar is mounted at a slight angle with respect to the support bar, allowing it to use the force of gravity in returning from an extended position to an initial rest position. The vertical support has mounting holes on either of two opposing sides in a particular pattern which allows one clearance bar to be mounted on either side, or a pair of clearance bars to be mounted on opposite sides of the vertical support by merely flipping the position of one of the clearance bars relative to the other.

### BACKGROUND OF THE INVENTION

### 1. Field of the Invention

The present invention relates generally to overhead clearance indicators used to warn the driver of a vehicle of an upcoming obstacle, such as the overhead of the canopy of a cashier's station, a structural beam or other such obstruction.

### 2. Description of the Prior Art

There are many instances in our everyday environment in which a vehicle approaches a parking area, tunnel, or drive-through commercial establishments, where the driver encounters some sort of height restraint indicator. These clearance indicators are sometimes referred to as “clearance bars.” These clearance indicators serve as a precursor to warn the vehicle driver of an upcoming obstacle such as the overhang of the canopy of a cashier's station, a structural beam of a multi-level parking lot, or other such obstruction.

These clearance bars may be painted with bright colors, or painted with reflective paint, in order to be more visible. Some of the clearance bars are supported or suspended from the obstruction 17 itself to provide an alert. Sometimes they are self-standing or self-supporting. The alert serves both to protect the canopy or overhead barrier from damage and further, to minimize the possibility of damage to the roof of a vehicle or the cargo secured to the top of a vehicle. Typically, the clearance indicator will be positioned in an area just prior to the obstacle in order to provide a warning to the driver upon entering the vicinity of the barrier or obstacle.

The exact nature of the clearance indicator may vary greatly, depending upon the installation. They may vary from very simple devices, to more complex arrangements. For example, US2004/0049959, published Mar. 18, 2004, by Venegas, Jr., shows a simple hanging clearance bar made up of an elongated enclosed, hollow plastic member, and fasteners on either end, permitting the member to be suspended for use.

U.S. Pat. No. 5,904,115, issued May 18, 1999, to Durbin et al., shows a more complicated assembly which includes a clearance pole with a first horizontal portion and a second vertical portion. The first and second pole elements are mounted so that the first element is rotatable with respect to the second about a vertical axis. The vertical portion of the assembly houses a polyethylene block which acts as a cam follower engaging a rod, bar, or tube which acts as a cam, the structures biasing the first pole element first portion to a home position. This reference is typical of those assemblies which feature some sort of cam follower as a part of the return mechanism of the apparatus.

U.S. Pat. No. 8,448,594, issued May 28, 2013, to Dukes, shows a device for providing a preliminary alert to the driver of a vehicle approaching an overhead obstacle. The inventive concept consists of a vertical mounting post to which is attached a non-marring horizontal height restrictor arm. The position of the height restrictor arm on the vertical post is at the same vertical distance from the roadway surface as is the vertical distance of the specific overhead obstacle for which an alert is provided. The height restrictor arm is affixed to the vertical post by means of a multi-directional pivotal connector comprising a hollow sphere, spring, and chain assembly. The 16 pivotal connector allows the height restrictor arm to move, after contact by a vehicle, in a multitude of directions, fore and aft, up or down.

Some of the prior art designs also used electronic alerts, in addition to simple mechanical actuators. For example, U.S. Pat. No. 4,916,429, issued to E. Hicks, shows a detector system was designed to operate in the area at the approach to an overhanging roof or canopy at a drive-through restaurant. The system employs a photoelectric switch which detects an over-height vehicle and immediately sends an audible and/or visual signal to the driver as he/she approaches the drive-through order window.

A similar alert scheme is shown in U.S. Pat. No. 5,390,719, to Barnes, which features a canopy assembly constructed with an over-height impact bar on its front frame. In the event that a high-rise vehicle makes contact with the impact bar, an alarm is emitted and the impact bar moves slightly backwards. Should the driver not stop the vehicle at this point, more contact pressure from the vehicle triggers the impact bar to send a release signal to a latch integral to the canopy mounting post. As the latch releases, the entire canopy swivels about the mounting post and clear of the path of the oncoming vehicle.

The above discussion is not intended to be an exhaustive listing of all the devices of this known type, but is meant to be merely illustrative of the state of the art.

In view of the existing state of the prior art, it is one primary object of the present invention to provide a simple and effective clearance indicator assembly which is not overly complicated or expensive to manufacture, and which is effective for its intended purpose of protecting vehicles and building structures from damaging contact.

It is also an object of the invention to provide a clearance bar assembly that mitigates problems associated with certain of the prior art designs, thereby ensuring greater care on the part of the vehicle driver and increasing the safety, convenience and efficiency of maneuvering past the obstacle or obstruction.

Additional objects, features and advantages will be apparent in the written description which follows.

### SUMMARY OF THE INVENTION

A clearance indicator assembly is shown for controlling the approach to a building structure. The indicator assembly includes a vertical support post securely mounted on a surrounding terrain and extending vertically upward therefrom. At least one horizontal clearance bar is mounted on the vertical support post to extend outwardly therefrom in a generally perpendicular direction. The horizontal clearance bar is positioned above the surrounding terrain a predetermined clearance height, indicating the maximum permissible height for a vehicle attempting to move past the indicator assembly. The preferred horizontal clearance bar has an angular “V” shape as viewed from the side or in cross-section, with an apex which points in the direction of an on-coming vehicle and oppositely extending, flared sides.

In one preferred form, the horizontal clearance bar is mounted on the vertical support post by a mounting mechanism made up of a mounting plate and an associated pivot mechanism which pivots the clearance bar between a first position and a second, displaced position when contacted by a vehicle. The mounting plate preferably has mounting holes provided thereon in a given pattern. The vertical support post also has mating mounting holes arranged in a given pattern. The mounting holes on the vertical support post are preferably offset from center slightly from the 17 pattern of holes on the mounting plate, so that the horizontal clearance bar is mounted at a slight upward angle with respect to the surrounding terrain. This angle can be, for example, on the order of 5°.

Most preferably, the mounting plate has four mounting holes provided thereon which are square with respect to an outer face of the mounting plate, and wherein the mating mounting holes 23 provided on the vertical support post are offset from center at a slight angle from the holes in the mounting plate, when the mounting plate is mounted on the vertical support post. For example, the vertical support post can be provided as a polygonal tubular member having two pairs of opposing sides. In this case, the support post can be provided with a second pre-drilled hole pattern opposite a first pre-drilled pattern which is a mirror image of the first, so that a first clearance bar can be mounted on either of opposite sides of the support post, or a pair of horizontal clearance bars can be mounted on opposite sides of the vertical support post.

The mounting mechanism used to mount the horizontal clearance bar relative to the vertical support post, in addition to the mounting plate, includes an associated barrel hinge fixed to the mounting plate, the clearance bar being rotatably mounted on the barrel hinge. A center bolt passes through a central opening in the barrel hinge, the bolt having an extended length which is fitted with a torsion spring at the bottom of the bolt which cooperates with the barrel hinge and mounting plate to pre-tension the horizontal clearance bar in a first, stationary position before the bar is contacted by a vehicle.

The assembly may also be provided with a stop bolt which extends outwardly from the clearance bar, the stop bolt having one end which contacts the mounting plate in the stationary, first position 13 at an approximate 90° contact point, the position of the stop bolt being adjustable in the field to 14 line up the horizontal clearance bar in a position approximately perpendicular to the vertical support post.

Because of the relative hole patterns in the mounting plate and the vertical support bar, a single horizontal clearance bar can be mounted on either of opposite sides of the vertical support post without modifying the support post or clearance bar. Alternatively, a pair of identical horizontal clearance bars can be mounted on opposite sides of the vertical support post by merely flipping one of the bars over with respect to the position of the other.

Additional objects, features and advantages will be apparent in the written description which follows.

### BRIEF DESCRIPTION OF THE DRAWINGS

FIG. 1 is a side elevational view of the clearance bar assembly of the invention showing a pair of clearance bar elements mounted on the vertical support post;

FIG. 2 is an isolated side view of one of the clearance bar elements used in the assembly of the invention;

FIG. 3 is an isolated, side view of the mounting plate and associated rotational components of the clearance bar assembly;

FIGS. 4A and 4B are isolated views of the vertical support post used in the clearance bar assembly, showing the uneven pattern of the mounting holes which are drilled into the post and which are used for supporting the mounting plate of the assembly;

FIG. 4C is a view similar to FIGS. 4A and 4B, but taken from a different side, showing the uneven pattern of the mounting holes on the two oppositely arranged mounting plates;

FIG. 5 is a partial perspective view of the vertical mounting post shown supporting one of the clearance bar elements, and showing the components of the rotational mechanism.

### DETAILED DESCRIPTION OF THE INVENTION

The present invention provides a clearance bar assembly which meets the foregoing described objectives. The invention described herein and the various features and advantageous details thereof are explained more fully with reference to the non-limiting examples which are illustrated in the accompanying drawing and detailed in the following description. Descriptions of well-known components and processes and manufacturing techniques are omitted so as to not unnecessarily obscure the workings of the invention. The examples used herein are intended 6 merely to facilitate an understanding of ways in which the invention herein may be practiced and to further enable those of skill in the art to practice the invention. Accordingly, the examples should not be construed as limiting the scope of the claimed invention.

As briefly discussed, the present invention presents a device for giving advance warning to a driver whose vehicle is approaching an overhead obstacle or barrier. The device is particularly useful at establishments such as drive through fast food restaurants, ATM machines and cashiers' windows located at bank facilities, multi-level parking decks, and the like. Essentially, the invention features a vertical mounting post onto which is attached a pivotable clearance bar element. The clearance bar is attached to the vertical mounting post by a mounting plate and an associated pivot housing. The pivot housing includes a barrel hinge and an elongated spring mechanism. Should a vehicle 17 contact the clearance bar element, the spring mechanism permits the clearance bar element to pivot between a first, stationary position and a second, displaced position. Contact with the clearance bar and subsequent movement or rotation alerts the driver that there is an imminent lack of clearance between the top of his vehicle and the upcoming obstacle. The construction according to the invention does not require any mounting structure above the horizontal clearance bar element. The horizontal clearance bar is securely biased in the stationary, first position and is retuned from the second, displaced position to a home position utilizing a simple, reliable, and effective mechanism.

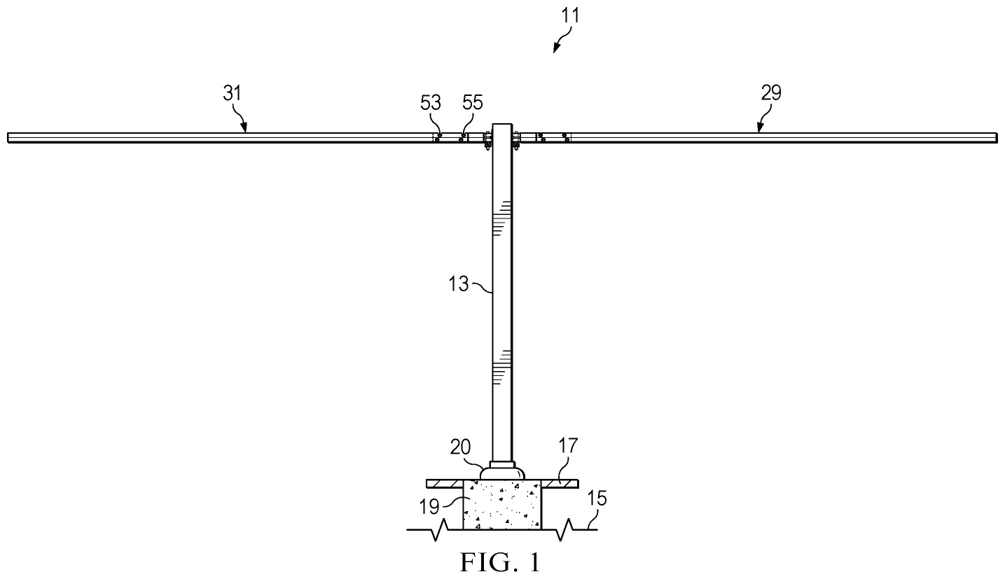

Turning to FIG. 1, there is shown a reversible clearance bar assembly of the invention, designated generally as 11. The assembly includes a vertical support post 13 securely mounted on a surrounding terrain 15 and extending vertically upward therefrom. The exact manner of mounting the vertical support post is not particularly critical, as long as it is sturdy and serves the intended purpose. In the example shown, a support plate 17 is incorporated in a concrete footer 19. The support plate can have, for example, drilled holes (not shown) for receiving upstanding bolts provided on the footer 19. The base 20 of the vertical support post could be welded to the support plate 17, or otherwise affixed, as by bolts, etc. The support plate 17 could, as easily be attached to wood, or some other foundation materials. Preferably, an embedded mounting base of some type is utilized by directly inserting the embedded mounting base into a concrete foundation.

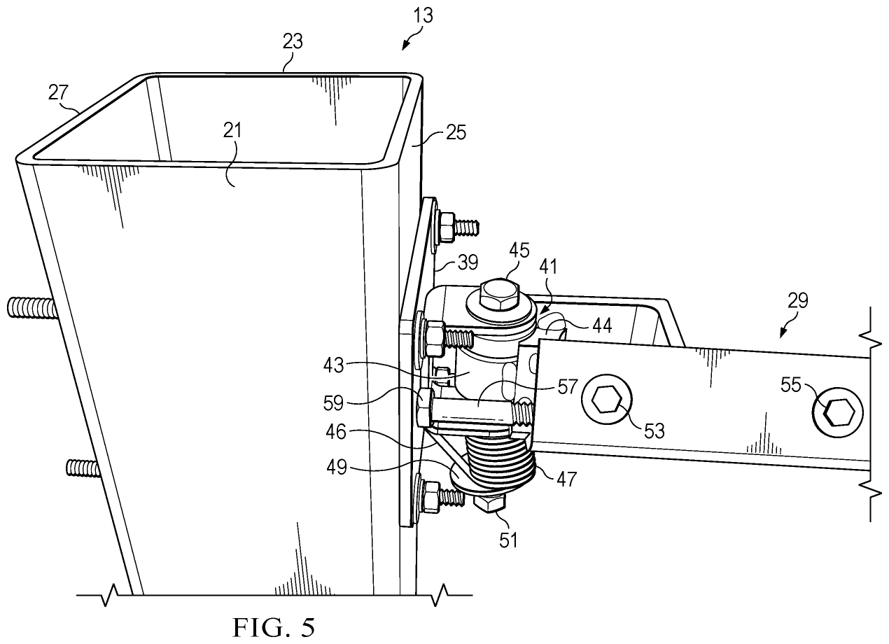

The vertical support post 13 extends directly upward form the mounting base 20 and is a hollow steel post of polygonal cross-section (see FIG. 5). For illustrative purposes, the post shown is depicted as square in shape, for example a 6×6 square steel tube, approximately 9 feet in height. As best seen in FIG. 5, the vertical support post has opposing sides 21, 23, and 25, 27.

At least one horizontal clearance bar 29 is mounted on the vertical support post 13 to extend outwardly therefrom in a generally perpendicular direction. In the preferred version of the 16 invention shown in FIG. 1, there are two identical horizontal clearance bars 29, 31, mounted on the vertical post 13. The horizontal clearance bars 29, 31, are positioned above the surrounding terrain 15 a predetermined clearance height indicating the maximum permissible height for a vehicle attempting to move past the indicator assembly. In the example shown, this is approximately 9 feet above the terrain.

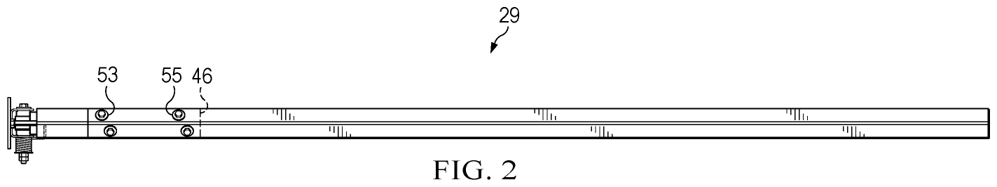

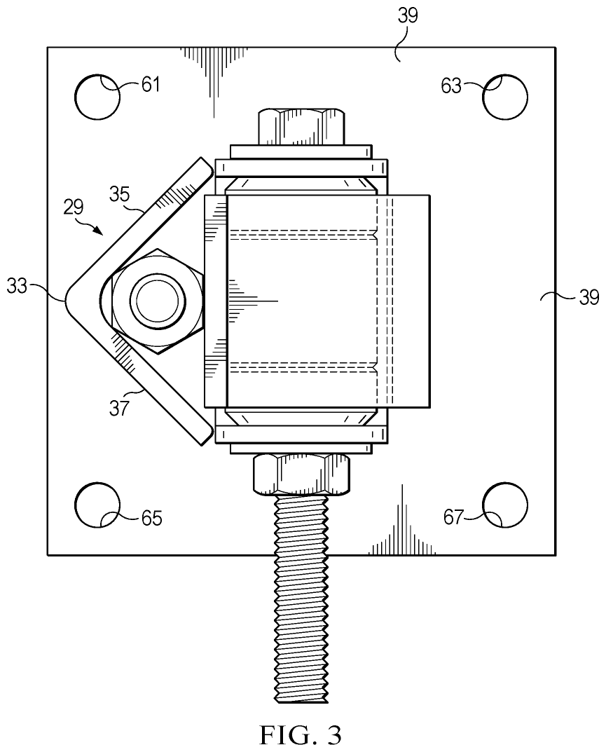

FIGS. 2, 3, and 5 show one of the clearance bars 29 in greater detail. It will be appreciated from FIGS. 3 and 5 that the clearance bar 29 has an angular “V” shape as viewed from the side or in cross-section, with an apex (33 in FIG. 3) which points in the direction of an on-coming vehicle and oppositely extending, flared sides 35, 37. In the example shown, the clearance bar 29 is formed from 2×2×¼ angle aluminum, the flared sides 35, 37, forming an approximate 90° angle. The “V” shape of the clearance bar offers a distinct advantage over other shapes in terms of the wind resistance presented by the clearance bar. In preliminary testing, it has been found that the angular “V” shape of the clearance bar reduces wind resistance of the bar by 30-35% when testing was done with a 2×2×¼ angle aluminum bar approximately 13 feet long with wind speeds up to mph.

As shown in FIGS. 3 and 5, the horizontal clearance bar 29 is mounted on the vertical support post by a mounting mechanism made up of a mounting plate 39 and an associated pivot mechanism which pivots the clearance bar 29 between a first, stationary position and a second, displaced position when contacted by a vehicle. The pivot mechanism includes a barrel hinge (41 in FIG. 5).

The barrel hinge has a rotatable mid-section (43 in FIG. 5) located between stationary upper and lower sections. The clearance bar 29 can be attached at the rotating mid-section 43 in any convenient mean. For example, one end of the clearance bar could be welded directly to the barrel hinge mid-section 43. In the particular arrangement shown in FIGS. 2 and 5, the barrel hinge mid-section 43 has an outwardly extending flange piece (44) welded thereto. The flange piece extends outwardly form the barrel hinge, for example, one to two feet and underlies the V-shaped clearance bar. The clearance bar 29 is attached to the flange by bolts (53, 55 in FIGS. 2 and 5). The terminating end of the flange is indicated by the dotted lines 46 in FIG. 2. This arrangement makes the V-shaped clearance portion of the assembly easily removable for replacement, in case of damage.

A center bolt 45 passes through a central opening in the barrel hinge, the bolt 45 having an extended length which is fitted with a torsion spring 47 on the bottom end thereof which cooperates with the barrel hinge and with the mounting plate 39 to pre-tension the horizontal clearance bar 29 in a first stationary position before the bar is contacted by a vehicle. The torsion spring 47 is held in place by a washer 49 and nut 51. The torsion spring is not shown in FIG. 3 for ease of illustration of the other components but can be seen in the view of FIG. 5. As shown in FIG. 5, the coil end portion 46 of the spring makes angular contact with the mounting plate 39, whereby movement of the clearance bar creates greater spring tension in the torsion spring 47. The particular spring arrangement also provides a certain degree of pre-tension to bias the clearance bar toward the first, stationary position.

Preferably, the mounting mechanism also includes a stop bolt 57 which extends outwardly from the flange 44 where the clearance bar is attached. The bolt 57 is received within a threaded bore (not shown) in the mounting flange, so that it can be threadedly adjusted inwardly or outwardly. As shown in FIG. 5, the end of the stop bolt 59 contacts the mounting plate 39 in the initial stationary position, keeping the clearance bar from rotating further about the rotating region 43. The stop bolt 57 is easily adjustable in the field to line up the horizontal clearance bar in a position approximately perpendicular to the vertical support post.

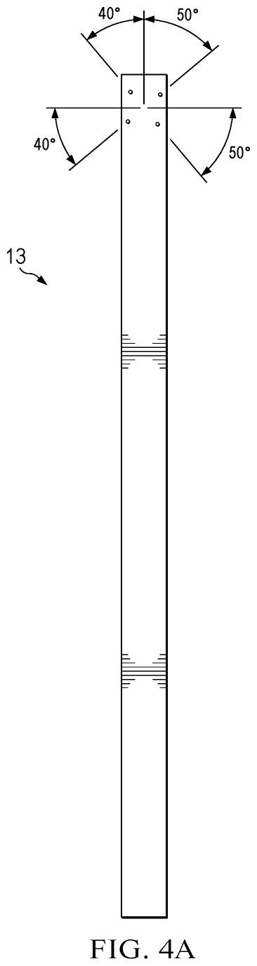

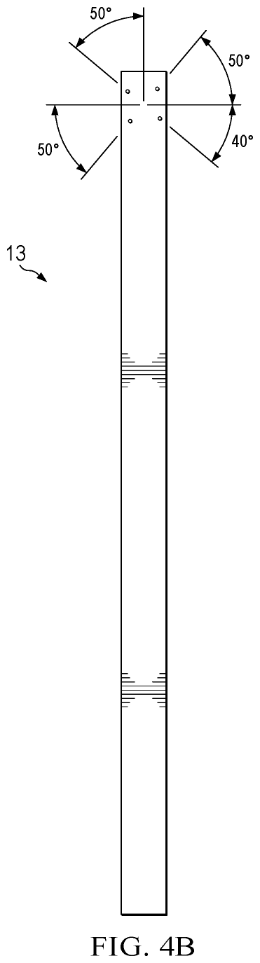

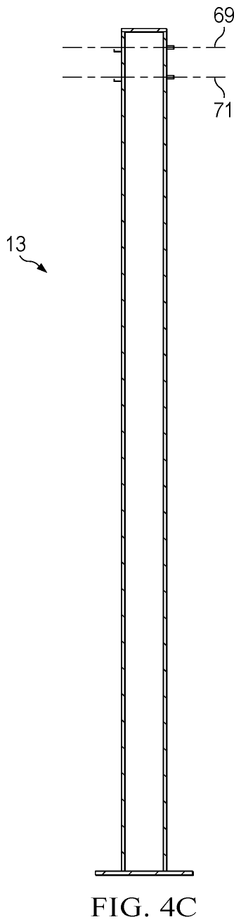

An important feature of the clearance bar assembly of the invention is its particular mounting method and its reversible nature. With reference first to FIG. 3, it will be evident that the mounting 8 plate 39 has mounting holes (61, 63, 65, 67) provided therein in a square pattern. With reference to FIGS. 4A-4C, the vertical support post 13 also has mating mounting holes arranged in a given pattern on either of two opposite sides (25, 27) thereof. The mounting holes on the vertical support post 13 are offset from center slightly from the pattern of holes on the mounting plate 39, so that the horizontal clearance bar is mounted at a slight upward angle with respect to the surrounding 13 terrain when positioned on the support post. This offset angle is generally in the range of about 2 to 10°, most preferably on the order of about 5°. In other words, the holes in the vertical support post are offset at an angle of about 5° from square, so that the mounting plate is canted at about a 5° angle when it is mounted on the vertical support post.

As will be apparent form FIGS. 4A and 4B, the vertical support post can be provided with a second pre-drilled hole pattern (FIG. 4B) opposite a first pre-drilled pattern (FIG. 4A) which is a mirror image of the first, so that a first clearance bar can be mounted on either of opposite sides of the support post, or a pair of horizontal clearance bars can be mounted on opposite sides of the vertical support post. The mirror image pattern of the holes can be clearly seen in FIGS. 4A and 4B and is illustrated in somewhat exaggerated form in the slight mis-alignment of the bolt axes shown as 69, 71, in FIG. 4C. This mirror image placement of the bolt holes allows a single clearance bar to be mounted on either side of the vertical post by merely flipping the bar over.

An invention has been provided with several advantages. The clearance bar assembly of the invention is simple in design and economical to manufacture. The bar is pre-tensioned to the closed, stationary position. The bar is mounted with a slight upward cant, so that the force of gravity works to help return it from a displaced position to the initial, stationary position. The special “V” shape of the clearance bar element reduces wind resistance and the tendency of the wind to move the bar. The hole pattern on the bar mounting plate and on the sides of the vertical support post allow a single bar or two oppositely arranged, identical bars to be mounted on the support post. A single clearance bar can be mounted on either of one of the oppositely arranged sides of the vertical support post by simply flipping the bar over in position.

While the invention has been shown in only one of its forms, it is not thus limited but is susceptible to various changes and modifications without departing from the spirit thereof.

What is claimed is:

1. A clearance indicator assembly for controlling approach to a building structure, comprising:
a vertical support post securely mounted on a surrounding terrain and extending vertically upward therefrom;
at least one horizontal clearance bar mounted on the vertical support post to extend outwardly therefrom in a generally perpendicular direction, the horizontal clearance bar being positioned above the surrounding terrain a predetermined clearance height indicating the maximum permissible height for a vehicle attempting to move past the indicator assembly;
the horizontal clearance bar having an angular “V” shape as viewed from the side, with an apex which points in the direction of an on-coming vehicle and oppositely extending, flared sides;
the horizontal clearance bar being mounted on the vertical support post by a mounting mechanism made up of a mounting plate and an associated pivot mechanism which pivots the clearance bar between a first, stationary position and a second displaced position when contacted by a vehicle; and
wherein the mounting plate has mounting holes provided thereon in a given pattern and the vertical support post has mating mounting holes arranged in a given pattern, and wherein the mounting holes on the vertical support post are offset from center slightly from the pattern of holes on the mounting plate, so that the horizontal clearance bar is mounted at a slight upward angle with respect to the surrounding terrain.

2. The clearance indicator assembly of claim 1, wherein the mounting plate has four mounting holes provided thereon which are square with respect to an outer face of the mounting plate, and wherein the mating mounting holes provided on the vertical support post are offset from center at a slight angle from the holes in the mounting plate, when the mounting plate is mounted on the vertical support post.

3. The clearance indicator assembly of claim 2, wherein the offset angle is on the order of 5°.

4. The clearance indicator assembly of claim 2, wherein the vertical support post is a polygonal tubular member having two pairs of opposing sides and wherein the support post is provided with a second pre-drilled hole pattern opposite a first pre-drilled pattern which is a mirror image of the first, so that a first clearance bar can be mounted on either of opposite sides of the support post, or a pair of horizontal clearance bars can be mounted on opposite sides of the vertical support post.

5. A clearance indicator assembly for controlling approach to a building structure, comprising:
a vertical support post securely mounted on a surrounding terrain and extending vertically upward therefrom;
at least one horizontal clearance bar mounted on the vertical support post to extend outwardly therefrom in a generally perpendicular direction, the horizontal clearance bar being positioned above the surrounding terrain a predetermined clearance height indicating the maximum permissible height for a vehicle attempting to move past the indicator assembly;
the horizontal clearance bar having an angular “V” shape as viewed from the side, with an apex which points in the direction of an on-coming vehicle and oppositely extending, flared sides;
the horizontal clearance bar being mounted on the vertical support post by a mounting mechanism made up of a mounting plate and an associated pivot mechanism which pivots the clearance bar between a first, stationary position and a second, displaced position when contacted by a vehicle, the pivot mechanism including an associated barrel hinge, the clearance bar being rotatably mounted on the barrel hinge, and wherein a center bolt passes through a central opening in the barrel hinge, the bolt having an extended length which is fitted with a torsion spring which cooperates with the barrel hinge to pre-tension the horizontal clearance bar in the first, stationary position before the bar is contacted by a vehicle; and
wherein the mounting plate has mounting holes provided thereon in a given pattern and the vertical support post has mating mounting holes arranged in a given pattern, and wherein the mounting holes on the vertical support post are offset from center slightly from the pattern of holes on the mounting plate, so that the horizontal clearance bar is mounted at a slight upward angle with respect to the surrounding terrain.

6. The clearance assembly of claim 5, wherein the holes in the vertical support post are offset at an angle of about 5° from square, so that the mounting plate is canted at about a 5° angle when it is mounted on the vertical support post.

7. The clearance assembly of claim 5, wherein the mounting mechanism includes a stop bolt which extends outwardly from the clearance bar and which contacts the mounting plate at one end when the horizontal clearance bar in the relaxed, rest position at an approximate 90° contact point, the position of the stop bolt being adjustable in the field to line up the horizontal clearance bar in a position approximately perpendicular to the vertical support post.

8. A method of assembling a clearance indicator for controlling approach to a building structure, the method comprising the steps of:
providing a vertical support post securely mounted on a surrounding terrain and extending vertically upward therefrom;
providing a first horizontal clearance bar for mounting on the vertical support post so that the clearance bar extends outwardly therefrom in a generally perpendicular direction, the horizontal clearance bar being positioned above the surrounding terrain a predetermined clearance height indicating the maximum permissible height for a vehicle attempting to move past the indicator assembly once mounted;
the horizontal clearance bar having an angular “V” shape as viewed from the side, with an apex which points in the direction of an on-coming vehicle and oppositely extending, flared sides;
providing a mounting mechanism for mounting the horizontal clearance bar on the vertical support post, the mounting mechanism being made up of a mounting plate and an associated pivot mechanism which pivots the clearance bar between a first, stationary position and a second, displaced position when contacted by a vehicle;
wherein the mounting plate has mounting holes provided thereon in a given pattern and the vertical support post has mating mounting holes arranged in a given pattern, and wherein the mounting 13 holes on the vertical support post are offset from center slightly from the pattern of holes on the mounting plate, so that the horizontal clearance bar is mounted at a slight upward angle with respect to the surrounding terrain;
wherein the vertical support post is a polygonal tubular member having two pairs of opposing sides and wherein the support post is provided with a second pre-drilled hole pattern opposite a first pre-drilled pattern which is a mirror image of the first; and
mounting the first horizontal clearance bar on a selected opposing side of the vertical support post.

9. The method of claim 8, wherein first horizontal clearance bar is removed and mounted on an opposing side of the vertical support post.

10. The method of claim 8, wherein a pair of identical horizontal clearance bars are mounted on opposing sides of the vertical support post, one of the clearance bars being flipped over in position with respect to the other.
